(19) United States
(12) Patent Application Publication
(10) Pub. No.: US 2006/0238035 A1
(43) Pub. Date: Oct. 26, 2006

(54) Electricity supply control system

(76) Inventor: John Roger Wainewright, Storridae (GB)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 11/110,370

(22) Filed: Apr. 20, 2005

(51) Int. Cl. H02B 1/24

(52) U.S. Cl. 307/116

(57) ABSTRACT

A control system for controlling the supply of electrical power to an apparatus, the system comprising a supply control device and a remote control, the supply control device comprising a power input, a power output, a control data input and a controller, the power input being arranged to receive electrical power from a supply, the power output being arranged to output electrical power to the apparatus, the control data input being arranged to receive control data from the remote control, wherein the controller is arranged to control the flow of electricity from the input to the output, the controller is further arranged to detect disconnection of the device from the apparatus or the power supply, and to send a signal to the remote control, and the remote control is arranged to respond to receipt of the signal by producing a warning arranged to notify a user of the disconnection.

### FIELD OF INVENTION

This invention relates to an electricity supply control device and a method of electricity supply control. More particularly, but not exclusively, it relates to a programmable device, and method, for controlling an electricity supply, that utilizes PIN code control to regulate electricity supplied to apparatus, for example a personal computer (PC) or a games console.

### BACKGROUND

The control and regulation of a voltage supply of apparatus, for example a PC, games console or television, is important where a child is using the apparatus away from parental supervision, particularly in regard of controlling unsupervised access to the Internet.

Plugs and timers that plug directly into wall sockets are known. Timers typically include either an analogue or digital timer device that is mounted in a wall socket, and which receives a standard plug from the apparatus. A user of the timer sets a start and finish time. The timer acts as a switch, allowing electricity to be supplied to the apparatus from the start time to the finish time and then preventing the supply of electricity.

Such a timer has a number of disadvantages associated with it. For example, the timer is easily circumvented by merely removing the timer from the socket and inserting the plug directly into the socket. Also, a user can readily alter, or override, the start and finish time associated with the timer. These disadvantages makes these known prior art timers unsuitable for controlling electricity supply where third party, for example parental or management, control of the apparatus is desired.

### SUMMARY OF THE INVENTION

According to a first aspect of the present invention there is provided an electricity supply control device comprising an input, an output, control data input means and processing means, the input being arranged to receive electricity from a supply, the output being arranged to selectively output electricity to an apparatus, the control data input means being arranged to receive control data, the processing means being arranged to control the flow of electricity from the input to the output dependent upon verification of user identification data, which comprises at least part of the control data, by the processing means.

This control device has the advantage over prior art devices that the use of user identification data allows a user, for example a parent, to restrict access to the apparatus by securely controlling the flow of electricity to the device.

The control data input means may comprise a keypad, which may comprise part of the device. The control data input means may comprise an infra-red or radio receiver, or transceiver, arranged to receive a control signal from a remote control, typically comprising a keypad. The device may be arranged to receive an encrypted control data signal from the remote control, and the processing means may be arranged to decrypt the encrypted control data signal. The remote control may be used for controlling a number of the devices independently, for example by transmitting a user identification data that is specific to a given device.

The control data input means may be arranged to transmit status data to the remote control. The status data may relate to any one, or combination, of the following: whether the device is operating in timed or constant mode, time remaining for the supply of electricity to the apparatus when the device is operating in timed mode, status of the supply.

The use of a remote control allows the setting of the device by a user who is not necessarily in the same room as the device. The use of a remote control also increases the utility of the device, as sockets are often located close to ground level, in awkward places such as under desks or beds. Thus, the remote control allows a user to set the device without having to crawl under, for example, a desk to set the device.

The device may comprise a display. The display may comprise a liquid crystal display (LCD). The display may be arranged to display the status of the flow of electricity through the device. The display mat be arranged to display the time remaining before the supply of electricity to the apparatus is prevented.

The user identification data when received by the device may comprise a numeric code, or an alphanumeric code. Typically, the code will comprise a four digit numeric code. The processing means may be arranged to prevent access to the device until recognized user identification data is entered at the control data input means.

The control data when received at the device may comprise a start time and a finish time that define a time period during which electricity is to be supplied to the apparatus.

The device may comprise a switching element arranged to control the flow of electricity through the device in response to a signal from the processing means. The processing means and/or the control data input means may be at least partially electrically screened from the switching means.

The screening of the switching means results in electromagnetic spikes generated on the execution of a switching operation not interfering with the operation of the processing means and/or the control data input means.

The device may comprise audio output means. The audio output means may comprise a speaker. The audio output means may be arranged to output an audible signal upon the data input means receiving the control data. The audio output means may be arranged to output an audible signal a predetermined time interval prior to the device preventing the flow of electricity to the apparatus. The time interval may be any one, or combination, of the following: 10 minutes, 5 minutes, 1 minute, 30 seconds, 10 seconds. The device may be arranged to execute an automatic shutdown of an apparatus of which the device comprises a part.

An audible warning prior to the device stopping the flow of electricity to the apparatus allows a user of the apparatus to make suitable preparations for a controlled shut down of the apparatus in order to prevent the loss of data. For example, applications upon a PC can be shut down and data saved. Similarly in the case of a games console a game can be saved at whatever stage a player has attained.

The device may have visual indicator means arranged to indicate that either, the device is receiving electricity from the supply, or that the device is operating in a programmed timer mode or both.

The device may comprise an internal power supply, for example a battery, which may be rechargeable, and which may recharge directly from the supply. Alternatively, or additionally, the device may be arranged to receive power from the supply, typically via a transformer.

According to a second aspect of the present invention there is provided a method of controlling the supply of electricity to an apparatus comprising the steps of: entering user identification data at a data entry means; validating said user identification data at processing means; and allowing electricity to be supplied to an apparatus should said user identification data be successfully validated at step ii).

The method may comprise entering a time period over which electricity is to be supplied at the data input means and supplying electricity to the apparats during said time period should said user identification be successfully validated at step (ii). The method may comprise preventing the supply of electricity to the apparatus one the time period has expired.

The method may comprise providing the data input means as a remote control which is remote from means for validating the user identification.

The method may comprise displaying the status of the flow of electricity upon either, or both, of the remote control or/and the means for validating the user identification.

The method may comprise outputting an audible warning a pre-determined amount of time prior to the end of the time period.

According to third aspect of the present invention there is provided a remote control suitable for use with a device according to the first aspect of the present invention.

The remote control may comprise a transceiver arranged to communicate with the device.

The remote control may comprise an audio output means arranged to output an audible signal in response to status data received from the device. The remote control may comprise a display means arranged to display a symbol indicative of status data received from the device.

According to a fourth aspect of the present invention there is provided a plug comprising a device according to the first aspect of the present invention.

According to a fifth aspect of the present invention there is provided electrical apparatus comprising a device according to the first aspect of the present invention.

The electrical apparatus may comprise any one, or combination, of the following: television, PC, games console, compact disc (CD) player, digital versatile disc (DVD) player, video cassette recorder (VCR), electric fire, photocopier, fax machine or any other suitable electrical apparatus.

According to a sixth aspect of the present invention there is provided an electrical adapter comprising a device according to the first aspect of the present invention.

The adapter may comprise a current monitoring means in communication with the processing means. The processing means may be arranged to generate a notification signal which can be transmitted to a remote control if the current monitoring means detects an interruption in electricity supply through the adapter.

The adapter may comprise a voltage monitoring means in communication with the processing means. The processing means may be arranged to generate a notification signal which can be transmitted to a remote control if the voltage monitoring means detects an interruption in electricity supply through the adapter.

The adapter may comprise a switching circuit in communication with the processing means. The processing means may be arranged to generate a notification signal which can be transmitted to a remote control if the switching circuit is open detects an interruption in electricity supply through the adapter. The switching circuit may comprise at least one biased contact associated with a cover of a socket opening.

### DESCRIPTION OF THE DRAWINGS

The invention will now be described, by way of example only, with reference to the accompanying drawings in which:

FIG. 1 is a schematic representation of a device and a remote control according to an embodiment of the present invention;

FIG. 2 is a schematic circuit diagram of an embodiment of a device according to at least an aspect of the present invention;

FIG. 3 is a schematic circuit diagram of a remote control according to at least an aspect of the present invention;

FIG. 4 is a schematic representation of a second embodiment of a device according to at least an aspect of the present invention;

FIG. 5 is a representation of a games console comprising a device according to at least an aspect of the present invention;

FIG. 6 is a flow chart detailing a method of controlling the supply of electricity to an apparatus according to an embodiment of the present invention;

FIG. 7 is a schematic representation of an electrical adapter comprising an embodiment of the present invention;

FIG. 8 is a schematic representation of an electrical adapter comprising a further embodiment of the present invention;

FIG. 9 is a schematic representation of an electrical adapter comprising a further embodiment of the present invention; and

FIG. 10 is a schematic representation of a connector according to a further embodiment of the invention.

### DETAILED DESCRIPTION

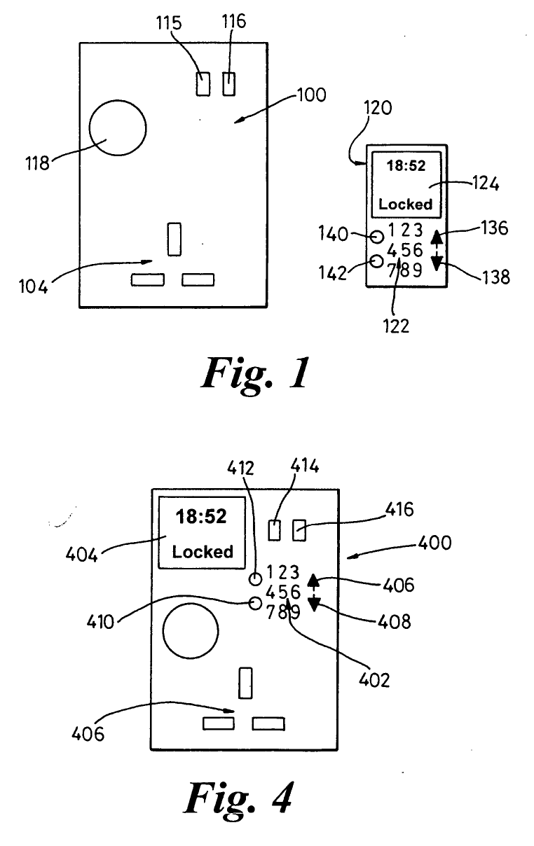

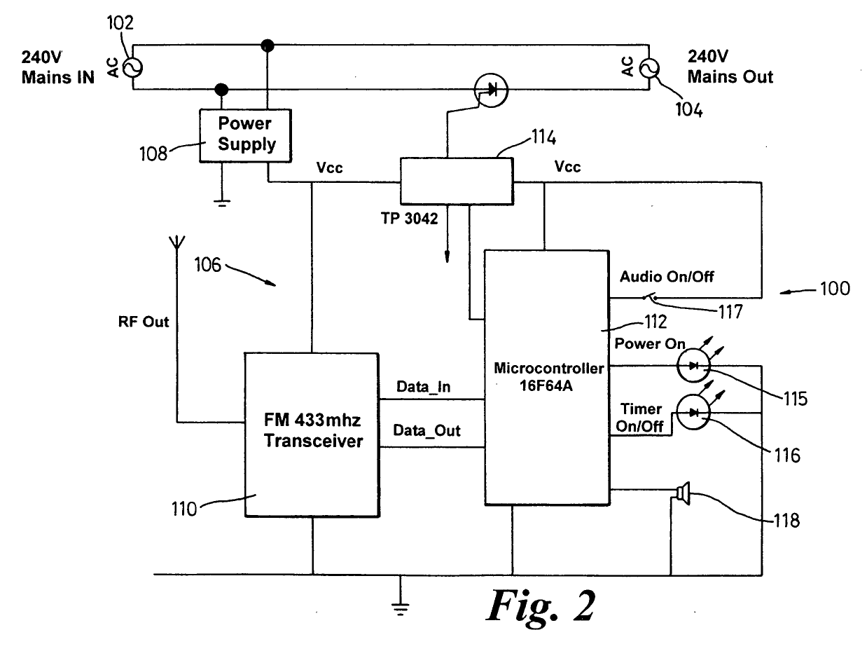

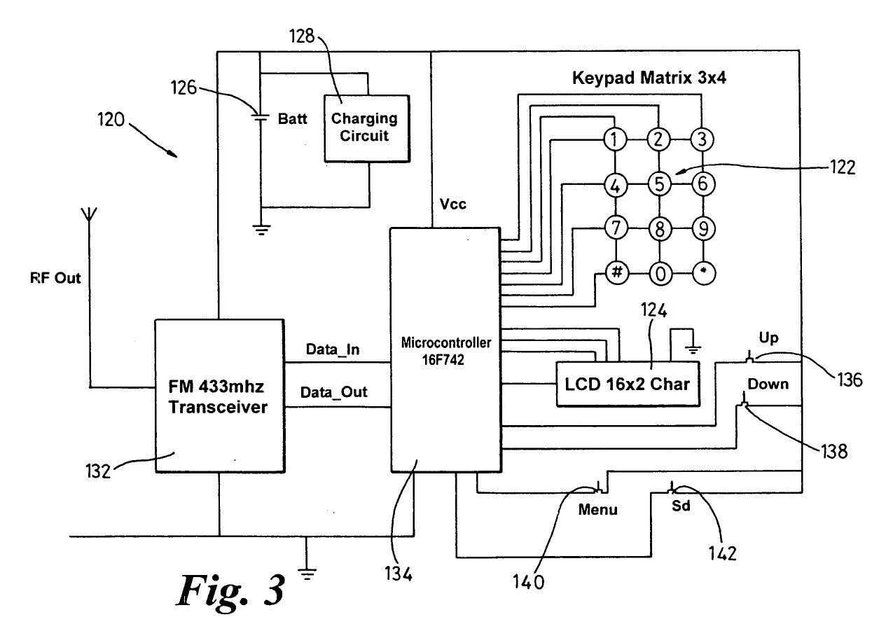

Referring now to FIGS. 1 to 3, a timer device 100 comprises a mains electricity input 102, a mains electricity output 104, and control circuitry 106. The electricity input 102 typically takes the form of a plug bayonet and the electricity output 104 typically takes the form of a plug socket.

The control circuitry 106 comprises a power supply unit 108 arranged to draw power from the electricity input 102, a transceiver 110, a microcontroller 112, a triac 114, two light emitting diode (LED) indicators 115, 116, an audio enable/disable switch 117 and an audio loudspeaker 118, typically a piezoelectric.

The power supply unit 108 draws power from the electricity input 102 and feeds the remainder of the control circuitry 106. The transceiver 110 is arranged to communicate with a remote control 120, to be described in detail hereinafter. The transceiver 110 typically operates at a frequency of 433 MHz, or thereabouts. It is envisaged that in some embodiments the transceiver may operate at infra-red wavelengths.

The LED indicator 115 is lit as long as the power supply unit 108 supplies power to the microcontroller 112. The switch 117 is used to enable and disable the loudspeaker 118.

Control data received by the transceiver 110 from the remote control 120 is passed to the microcontroller 112. The microcontroller 112 processes the control data received by the transceiver in order to verify that 8-bit encrypted user identification (UID) data transmitted by the remote control 120 corresponds to UID data stored in the microcontroller 112. If the received UID does not match the stores UID the microcontroller 112 ignores the remainder of the control data transmitted by the remote control 120. However, if the received UID and the stored UID do match the microcontroller 112 processes the remainder of the control data. The control data typically includes a start time and a finish time that define a time interval during which electricity is to be supplied to an apparatus, typically a PC, games console or the like. The microcontroller 112 compares these times to an internal clock thereof and outputs power to the LED 116 that is illuminated to indicate that the device 100 is operating in a timed program mode.

The default status of the triac 114 is to prevent the passage of electricity thereacross. At the start time detailed in the control data the microcontroller 112 outputs a control signal to a gate 122 of the triac 114 in order to allow it to conduct in both forward and reverse directions, a necessity where unrectified a.c. voltages are required. This allows electricity to flow between the input 102 and the output 104.

Should the switch 117 be in an “Audio On” position, at a predetermined time prior to the finish time detailed in the control data, typically five minutes prior to the finish time, the microcontroller 112 outputs an audio signal to the loudspeaker 118 that emits a warning sound so that a user of the apparatus has the opportunity to close down the apparatus and any applications running thereupon in a controlled manner. A similar, or different, warning sound can be emitted from the loudspeaker 118 at, for example, thirty seconds prior to the finish time detailed in the control data.

Upon the finish time contained in the control data being reached the microcontroller 112 ceases to output the control signal to the gate of the triac 114, and the triac 114 reverts to its default non-conducting state, thereby preventing the flow of electricity between the input 102 and the output 104 of the device 100.

It is also envisaged that the control data can include a change to the UID to be stored in the microcontroller 112, or instructions to synchronise the clock of the microcontroller 112 with an internal clock of the remote control 120.

The remote control 120 comprises a keypad 122, an LCD display 124, a battery 126 with an associated charging circuit 128 and control circuitry 130.

The battery 126 provides power for the remote control 120, and is typically an AA size NiCd battery. The recharging circuitry 128 allows the battery 126 to be recharged from a mains electricity supply whilst still in the remote control 120, for example in a charging cradle, or a standard a.c. adapter.

The control circuitry 130 comprises a transceiver 132, a microcontroller 134, up and down keys 136, 138, a menu key 140 and a set key 142.

The transceiver 132 operates at the same frequency as the transceiver 110 of the device 100.

A user of the remote control 120 presses the menu key 142 and is requested to enter a four digit UID on the key pad 122. The keystrokes pass to the microcontroller 134 where the UID entered by the user is compared to a UID stored therein. Should the UID entered by the user match the UID stored in the microcontroller 134 the user has access to a number of options that are displayed on the LCD display 124. The options typically include such options as set time, lock, set UID, input time interval. The options can be scrolled through using the up and down keys 136, 138 and selected using the set key 142.

Whilst the remote control 120 is in standby mode the LCD display 124 displays the time, in twenty-four hour. The time displayed on the LCD display 124 can be set by navigating through the menu options on the display 124 using the menu key 140 and pressing the set key 142. The desired time is selected using the up and down keys 136, 138 and the pressing the set key 142 once more. The setting of the time resets an internal clock within the microcontroller 134. This function is unavailable when the remote control 120 is locked as this prevents unauthorized alteration of the time in the microcontroller 112 of the device 100.

Should the user elect the lock option, the microcontroller 134 disables all functions except UID code entry, and the time and the word “LOCKED” are displayed upon the LCD display 124. In order to unlock the remote control a UID matching that stored in the microcontroller 134 must be entered at the keypad 122 and verified by the microcontroller 134.

In order to change the UID, the current UID must be entered at the keypad 122 and verified by the microcontroller 134. A new UID is then entered at the keypad 122 by the user and stored in the microcontroller 134. The new UID must be re-entered by the user in order that it can be confirmed by the microcontroller 134.

The remote control 120 can be used to set the device 100 to operate in a non-timed constant mode to allow the constant supply of electricity to a device if desired

The time interval input is the period of time during which electricity is to be allowed to flow between the input 102 and the output 104 of the device 100. This is entered in terms of a start time and a finish time in the same manner as setting the time on the remote control 120 as described hereinbefore. Alarm periods are preferably set by the manufacturer, these are the periods prior to the end of the time interval that audible warnings are to be emitted by the loudspeaker 118 of the device 100, for example five bleeps five minutes prior to the electricity supply being stopped and a continuous sound one minute prior to the electricity supply being stopped. It is envisaged that is some embodiments the user may be able to define their own alarm period.

Once the time interval, and any alarm periods, have been entered it is sent along with a remote control UID from the microcontroller 134 to the transceiver 132 as a stream of control data. Typically, the transceiver 132 transmits the control data to the device 100, as an eight bit encrypted signal, where it is processed as described hereinbefore. The remote control 120 is in communication with the device 100 and the status of the device 100 is passed to the remote control 120. For example, the device 100 is arranged to monitor whether electricity is flowing through it from the power input to the power output. This can be used as an indication of whether the device 100 has been disconnected or bypassed. This information is sent to the remote control 120 which is arranged to display an appropriate message on its screen 124. This enables a person operating the remote control 120 to monitor the status of the device 100 and hence to detect if the device, and hence the timing control that it provides, has been bypassed. The device 100 can be arranged to monitor its status in a number of ways, examples of which are described in relation to other embodiments described below. However, it will be appreciated that designing other circuits to detect the disconnection of the device 100, either from a wall socket or from the apparatus to which it is supplying power, is within the abilities of the man skilled in the art. Other information about the status of the device 100 can also be transmitted to and displayed on the remote control 120, such as the amount of time before a timed period of usage will end.

Referring now to FIG. 4, a second embodiment of the a timer device 400 comprises an keypad 402, an LCD screen 404, a mains output socket 406, up and down keys 408, a menu key 410, a set key 412 and two LED indicators 414, 416.

The timer device 400 operates in a similar manner to the timer device 100 except that code entries are made directly to a microcontroller (not shown) at the keypad 402, rather than via a remote control. This removes the need for the transceiver 110 of the device 100. The screen 404, up and down keys 408, the menu key 410 and the set key 412 carry out the same functions as they do on the remote control 120. The LED indicators 414, 416 correspond to the LED indicators 115, 116 of the device 100.

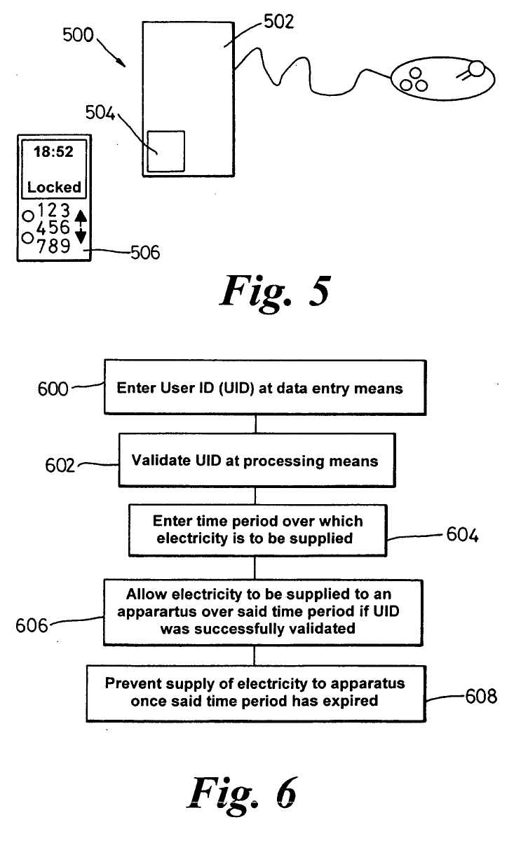

Referring now to FIG. 5, it is envisaged that a timer device according to the present invention need not be mounted into a socket but can be incorporated directly into the apparatus that it is intended to regulate the supply of electricity to, for example a games console 500. The console 500 comprises a processor unit 502 that receives electricity via a timer device 504 according to an embodiment of the present invention. This allows access to the console to be controlled by the use of a UID code typically transmitted from a remote control 506.

Thus, a parent can control the amount of time a child spends playing on a games console, accessing the Internet or watching television without necessarily being present in the same room as the child. Similarly, a manager can maintain out of office hours control over access to apparatus such as a photocopier, a fax machine or a PC.

It will be understood that it is envisaged that a device according to the present invention can be incorporated into any suitable electrical apparatus.

It is also envisaged that a device according to the present invention can be hard wired onto a cable as a plug, the plug will have a standard fuse mounting arrangement to allow matching to the plug to it's expected loading. The device can be moulded onto a mains lead, for example a D-plug that fits most PC's and supplied with a PC. Alternatively, the device can be mounted in a wall socket.

Referring now to FIG. 6, a method of controlling the supply of electricity to an apparatus comprises the steps of entering user identification data at a keypad (Step 600). The user identification data is validated at a processor (Step 602) and a time period over which electricity is to be supplied is entered at the keypad (Step 604). Electricity is supplied to an apparatus over the defined time period if the user identification data is successfully validated (Step 606). The supply of electricity to the apparatus is prevented once the defined time period has expired (Step 608).

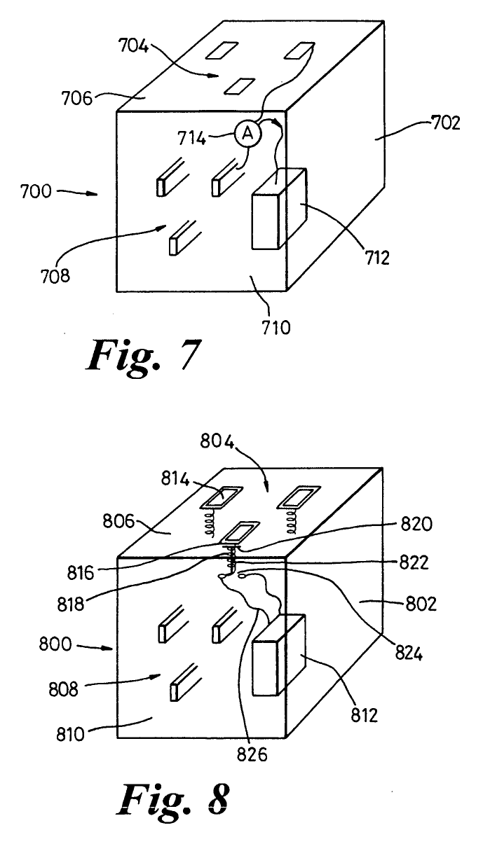

Referring now to FIG. 7, an adapter 700 comprises a body 702 having a socket arrangement 704 in a first face 706 thereof and a plug arrangement 708 projecting from a second face 710 thereof. The socket arrangement 704 and plug arrangement 708 are in electrical communication with each other. The body 702 houses control circuitry 712 arranged to regulate the flow of electricity through the adapter 700 in response to the entry of a UID as described hereinbefore in relation to the transceiver-microcontroller arrangements FIGS. 1 to 6.

Adapters have the known problem that they can be removed from a wall socket or an appliance's plug can be removed from the adapter and the appliance plugged directly into the wall socket thereby circumventing the control circuitry 712.

In order to overcome this the adapter 700 comprises a current sensing circuit 714 arranged to detect the flow of electrical current through the adapter 700 to an appliance. The current sensing circuit 714 is in communication with the control circuitry 712 and the control circuitry 712 is arranged to determine whether a load, i.e. an appliance, is attached to the socket 704 and also if the adapter 700 is programmed to allow current to flow to the appliance.

If the current sensing circuit 714 determines that a current is not flowing to the appliance, i.e. the appliance has been disconnected from the adapter 700 or the adapter 700 has been disconnected from the wall socket, and that the adapter 700 is programmed to allow current to flow to the appliance, the control circuitry 712 is arranged to send a signal to a remote control, not shown but substantially as described hereinbefore with reference to FIGS. 1, 3 and 5. The warning signal causes the remote control to either emit an audible warning, display a message upon a screen thereof or both. This warning alerts a user of the device to the fact that the wall socket-adapter-appliance plug arrangement has been tampered with and an attempt made to circumvent the control circuitry 712.

Referring now to FIG. 8, an adapter 800 comprises a body 802 having a socket arrangement 804 in a first face 806 thereof and a plug arrangement 808 projecting from a second face 810 thereof. The socket arrangement 704 and plug arrangement 708 are in electrical communication with each other. The body 802 houses control circuitry 812 arranged to regulate the flow of electricity through the adapter 800 in response to the entry of a UID as described hereinbefore in relation to the transceiver-microcontroller arrangements FIGS. 1 to 6.

The openings 814 of the socket 804 have cover plates 816 that are biased into a closed position, typically by springs 818. The cover plates 816 are forced into an open configuration by the pins of an appliance's plug as they are located in the adapter 800. A base plate 820 is attached to a spring 818 adjacent the cover plate 816 and has a rod 822 projecting away from the cover plate 816 internally of the spring 818. The rod 822 extends to close to the opposite end of the spring 818 from the cover plate 816 but does not pass beyond said opposite end of the spring 818. A switch 824 is mounted in the adapter 800 adjacent the free end of the rod 822 such that as the cover plates 816 is opened by the pins of the appliance's plug the switch 824 is closed. The closing of the switch 824 completes a circuit 826 which indicated to the control circuitry 812 that the appliance's plug is located in the adapter 800.

If the switch 824 is opened the circuit 826 is broken and the control circuitry 812 determines that the appliance's plug has been disconnected from the adapter 800. The control circuitry 812 then determines if the adapter 800 is programmed to allow current to flow to the appliance or not. If the circuit 826 is broken, and the adapter 800 is programmed to allow current to flow to the appliance, the control circuitry 812 is arranged to send a signal to a remote control, not shown but substantially as described hereinbefore with reference to FIGS. 1, 3 and 5. The warning signal causes the remote control to either emit an audible warning, display a message upon a screen thereof or both. This warning alerts a user of the device to the fact that the wall socket-adapter-appliance plug arrangement has been tampered with and an attempt made to circumvent the control circuitry 812.

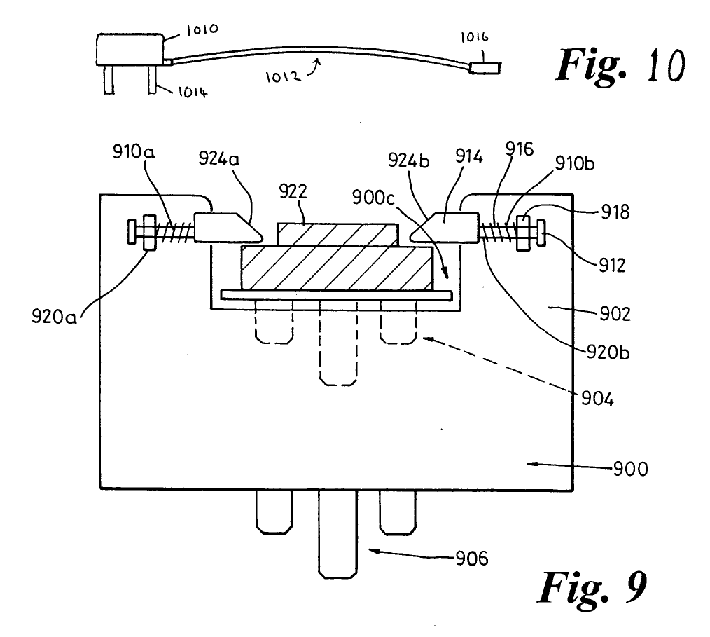

Referring now to FIG. 9, an adapter 900, as described hereinbefore with reference to either of FIG. 7 or 8, comprises a body 902, typically a plastics molding, having a socket arrangement 904 and a plug arrangement 906 upon opposite faces thereof. The socket arrangement 904 and the plug arrangement 906 are in electrical communication. The adapter 900 comprises an electricity supply control device as described hereinbefore in relation to FIGS. 1 to 6 to regulate the flow of electricity through the adapter 900. A current sensing circuit as described hereinbefore in relation to FIG. 7 and/or a spring-switch arrangement as described hereinbefore in relation to FIG. 8 can also be included in the adapter 900 to provide notification of tampering with the adapter to a user.

The body 902 has a recess 908 therein about the socket arrangement 904. Two latches 910a,b are mounted in openings in walls of the recess 908, typically opposite each other. Each latch 910a,b has a disc shaped end portion 912 that resides within the body 902 and a trapezoidal free head portion 914. Respective elongate neck portions 916 join the end portion 912 to the head portion 914 of each latch 910a,b. Each neck portion 916 passes through a mounting post 918 in the body 902 such that respective springs 920a,b are compressed between the mounting posts 918 and the head portion 914 of each latch 910a,b and bias the head portion 914 into the recess 908. The end portion 912 lies on the opposite side of the post 918 and retains each latch 910a,b in position.

As a plug 922 is inserted into the recess 908 sloping surfaces 924a,b of the head portions 914 are engaged and the latches 910a,b, are forced outward of the recess 908 into the body 902 and allow the plug 922 to pass into the recess 908 and engage the socket arrangement 904. The latches 910a,b are biased inward of the recess once the plug has almost fully, or fully, engaged the socket arrangement 904. Flat undersurfaces 926a,b of the head portion 914 act to prevent removal of the plug 922 from the adapter 900 without active outward biasing of the latches 910a,b thereby preventing accidental removal of the plug 922 from the adapter 900.

It is envisaged that with the embodiments of the invention described in relation to FIGS. 7 and 8 an appliance's standard plug will typically be retained in the adapter by use of mechanical means, strap, slides or cover or other means, thereby minimizing the risk of accidental removal of the plug from the adapter and their associated warnings.

Referring to FIG. 10, in a further embodiment of the invention, the timer and control device is incorporated in the plug 1010 of a connector lead 1012. The plug 1010 has connector pins 1014 to enable it to be inserted into a standard wall socket power supply. The other end of the lead 1012 includes a further plug 1016 for connection to the apparatus to be powered via the lead. The plug 1010 can include the features of any of the embodiments of FIGS. 1 to 8.

We claim:

1. A control system for controlling the supply of electrical power to an apparatus, the system comprising:
a remote control;
a supply control device, the supply control device comprising:
a power input arranged to receive the supply of electrical power;
a power output arranged to output electrical power to the apparatus;
a control data input arranged to receive control data from the remote control; and
a controller arranged to control flow of electrical power from the power input to the power output, the controller is further arranged to detect disconnection of the supply control device from the apparatus or the supply of electrical power, and arranged to send a signal to the remote control; and
wherein the remote control is arranged to respond to receipt of the signal by producing a warning arranged to notify a user of disconnection.

2. The system according to claim 1 wherein the remote control is arranged to transmit an encrypted control data signal, and the control data input is arranged to receive the encrypted control data signal from the remote control.

3. The system according to claim 2 wherein the controller is arranged to decrypt the encrypted control data signal.

4. The system according to claim 1 wherein the remote control is arranged to send user identification data to the supply control device, and the controller is arranged to respond to the control data input only on receipt of the user identification data.

5. The system according to claim 1 wherein the controller is arranged to receive data defining a period having a start time and a finish time, and to prevent the supply of electrical power to the apparatus outside said period.

6. The system according to claim 1 including a switching element arranged to control the flow of electricity from the power input to the power output, wherein at least one of the controller and the control data input is at least partially electrically screened from the switching element.

7. The system according to claim 1 wherein the device comprises audio output and is arranged to output an audible signal upon receipt by the control data input of the control data.

8. The system according to claim 1 wherein the device comprises audio output and is arranged to output an audible signal a predetermined time interval prior to the device preventing the flow of electricity to the apparatus.

9. The system according to claim 1 wherein the device comprises an electrical adapter.

10. The system according to claim 1 wherein the device comprises a connector lead.

11. The system according to claim 1 wherein the device comprises a current monitor and the controller is arranged to detect said disconnection using the current monitor.

12. The system according to claim 1 wherein the device comprises a voltage monitor and the controller is arranged to detect said disconnection using the voltage monitor.

13. The system according to claim 1 wherein the device includes a latch arranged to retain a plug in engagement with the device.

14. A remote control for a device, the remote control comprising:
a signal receiving member to receive a signal from the device;
a response member to respond to receipt of the signal; and
wherein said response member produces a warning to notify a user of disconnection of the device.

15. The remote control according to claim 14, further comprising a transceiver arranged to communicate with the device.

16. The remote control according to claim 14, further comprising an audio output arranged to output an audible signal in response to receipt of the disconnection signal.

17. The remote control according to claim 14, further comprising a display to display a symbol indicative of said disconnection.

18. A device being arranged to control the supply of electrical power to an apparatus, said device comprising:
a power input arranged to receive the supply of electrical power;
a power output arranged to output electrical power to the apparatus;
a control data input arranged to receive control data from a source; and
a controller arranged to control the flow of electrical power from the power input to the power output, and to detect disconnection of the device from the apparatus or the supply of electrical power, and to send a disconnection signal indicative of said disconnection.

19. The device according to claim 18, wherein the source comprises a remote control and wherein the disconnection signal is sent to the remote control.

20. The device according to claim 19, wherein the remote control is arranged to respond to receipt of the disconnection signal by producing a warning arranged to notify a user of disconnection.
